(19) United States
(12) Patent Application Publication
(10) Pub. No.: US 2015/0350121 A1
(43) Pub. Date: Dec. 3, 2015

(54) A METHOD AND SYSTEM FOR PROVIDING MULTITHREADED COMMUNICATION

(71) Applicant: Nitin PANDEY, (US)

(72) Inventor: Nitin PANDEY, Haryana, Gurgaon (IN)

(21) Appl. No.: 14/655,955

(22) PCT Filed: Dec. 24, 2013
(86) PCT No.: PCT/IN2013/000798

§ 371 Date: Jun. 26, 2015

(30) Foreign Application Priority Data
Dec. 28, 2012 (IN) 4042/DEL/2012

(51) Int. Cl. H04L 12/58; H04L 29/06

(52) U.S. Cl. CPC H04L 51/04; H04L 67/42

(57) ABSTRACT

The present disclosure provides a system and method multithreaded communication. A user operating at a client device communicates a request for searching a particular keyword(s) to another user. Said communicating user in response performs a search at his/her client device. Further, the (chat) communication server is specifically configured to, simultaneously and in parallel, present said search process in progress and results so produced in real time at the client device of said requesting user.

### TECHNICAL FIELD

Embodiments of the present disclosure relates to allowing dynamic communication over computer networks, and more specifically, but not limited to, a system and method for providing multithreaded communication and selectively allowing a plurality of users to dynamically communicate over such networks.

### BACKGROUND

Telecommunication in the modern era is the science and practice of transmitting information by electromagnetic means. Telecommunication has experienced enormous growth in the past years. The use of electronic devices such as mobile phones, smart phones, and personal digital assistants (PDAs) has increased tremendously. The growth in the usage of electronic devices is also revolutionizing telecommunication services offered to subscribing customers.

One of the well known applications of telecommunication utilizing World Wide Web is online communication (chat) that broadly refers to any kind of communication over the Internet that offers a real-time direct transmission of generally text-based messages from a sender to a receiver.

Online communication (chat) may address point-to-point communications as well as multicast communications from one sender to many receivers and voice and video communication (chat) or may also refer to a web conferencing service.

Thus, online communication (chat) includes any direct text-based or video-based (webcams), one-on-one communication (chat) or one-to-many group communication (chat), using tools such as instant messengers, Internet Relay communication (Chat), talkers etc.

Online communication (chat) facility is therefore relatively well known in the art. One of the limitations of the existing online communication (chat) facility is that the participating users most of the time are only able to send a particular set of messages to the receiving party i.e. messages that are typed directly into a (chat) graphical window.

Thus, there is no way whereby another particular set of messages, including but not limited to e.g. search results generated by one participating users (in addition to (chat) communication messages) are made dynamically available to other participating user(s) who may have requested such search results.

Particularly, the existing technologies do not provide a mechanism whereby a particular set of participating users can share the workload in way such that a piece of work is performed and shared seamlessly across multiple client machines and multiple users operating said client machines have real time access to the process (work) being carried out and the associated results.

However, there has been an increasing and long felt need to provide such interactive features that allow participating users to automatically, dynamically and on-demand exchange desired information apart from usual (chat) communication messages.

Therefore, a system and method is provided to optimize online (chat) communication over communication networks is required. The method and system of present invention overcome above and many other disadvantages of the existing online chat utilities as herein described with reference to accompanying drawings.

### SUMMARY

For purposes of summarizing, certain aspects, advantages, and novel features of the disclosure have been described herein. It is to be understood that not necessarily all such advantages may be achieved in accordance with any one particular embodiment of the disclosure. Thus, the present disclosure may be embodied or carried out in a manner that achieves or optimizes one advantage or group of advantages as taught herein without necessarily achieving other advantages as may be taught suggested herein.

All the embodiments of the present invention are applicable to both a system and method in line with the objectives of the present invention.

The present invention provides a method and a corresponding system for providing multithreaded communication in a network environment, comprising: initiating a request by at least a first client device towards a first server for allocation of a communication channel(s) for communicating with a second client device and carrying out a plurality of predetermined tasks; providing a user interface(s) by the first server coupled with a second server, to said first client device and said second client device as an indication of allocation of the communication channel; delegating a predetermined task having measurable results by the first client device, to be carried out by the second client device; performing said task(s) by the second client device; wherein the first server in combination with the second server is specifically configured to simultaneously and in parallel forward and, render task progress and generated results on execution of said task in real time at the first client device and second client device.

The system and method for present invention provide for first client device and second client device having a plurality of telecommunication devices that are configured to perform two-way communication.

In the ambit of the present invention first server is a specialized server computer to enable users to use client devices to instantly communicate via text, images, videos etc.

The method and system of the present invention provide for a second server is link server configured to manage, hypermedia information, comprising of links and anchors associated with predefined resource(s) on the network.

The user interface of the present invention comprises of graphical user interface having graphical window(s) for accepting user input.

The predetermined task(s) of the present invention in an embodiment is a request for search based on predetermined criteria and measurable results are search results.

In an embodiment of the present invention, registered users are able to communicate over a communication network platform providing one to one communication (chat) as well as group communication (chat) environment.

In another embodiment of the present invention, a participating user can go off line in a way such that said user's communication (chat) messages are not visible in the history of other participating user(s).

In another embodiment of the present invention, participating user(s) may selectively invite other user(s) for participating in such an online communication (chat) community and/or may selectively remove other participating user(s).

In another embodiment of the present invention, participating user(s) are provided with a technical feature of performing an on demand search on behalf of the other participating user and allowing dynamic access of the search results to said other participating users.

These and other embodiments of the present disclosure will also become readily apparent to those skilled in the art from the following detailed description of the embodiments having reference to the attached figures, the disclosure not being limited to any particular embodiments disclosed.

### BRIEF DESCRIPTION OF THE DRAWINGS

For a better understanding of the embodiments of the systems and methods described herein, and to show more clearly how they may be carried into effect, reference will now be made, by way of example, to the accompanying drawings, wherein:

FIG. 1 illustrates a diagrammatic representation of an environment in which system a (100) operates, in accordance with one or more embodiments of the present disclosure.

FIG. 2 illustrates a diagram depicting block architecture of the instant invention in accordance with an embodiment of the present disclosure.

FIG. 3 illustrates an exemplary screen shot of the (chat) graphical window (301) as generated by the (chat) communication server (207) of the present invention, in accordance with the present disclosure.

### DETAILED DESCRIPTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The illustrative embodiment provides an approach to internet access that is also well suited for fixed or mobile users. First, the users may choose the, quantity of access that meets their anticipated needs. Second, the client may access the portable document from multiple login sites and from multiple machines.

The figures depict a simplified structure only showing some elements and functional entities, all being logical units whose implementation may differ from what is shown.

The connections shown are logical connections; the actual physical connections may be different. It is apparent to a person skilled in the art that the structure may also comprise other functions and structures. It should be appreciated that the functions, structures, elements and the protocols used in communication are irrelevant to the present disclosure. Therefore, they need not be discussed in more detail here.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

The features provided by the disclosed system in the present disclosure, may be wirelessly accessed remotely, in one or more embodiments, and/or through a wireless network. Such types of wireless network service providers operate and maintain the computing systems and environment, such as server system and architectures. Typically, server architecture includes the infrastructure (e.g. hardware, software, and communication lines) that offers wireless network services.

For the most part, the operations described herein are operations performed by a handset, computer or a machine in conjunction with a human operator or user that interacts with the computer or the machine. The programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein.

It should be understood that embodiments of the present disclosure may be included in various types of wireless communication networks intended to be within the scope of the present disclosure, although not limited to, a GSM network, a CDMA network, TDMA, c FDMA, OFDMA, SC-FDMA, UTMS, a worldwide interoperability for microwave access (WiMAX) network, a WCDMA network, a time division synchronous code division multiple access (TD-SCDMA) network, a CDMA2000 network, a personal handy phone system (PHS) network, a cluster network, a long term evolution (LTE) network, an air interface evolution (AIE) network, and such other network. The terms “network” and “systems” are often used interchangeably.

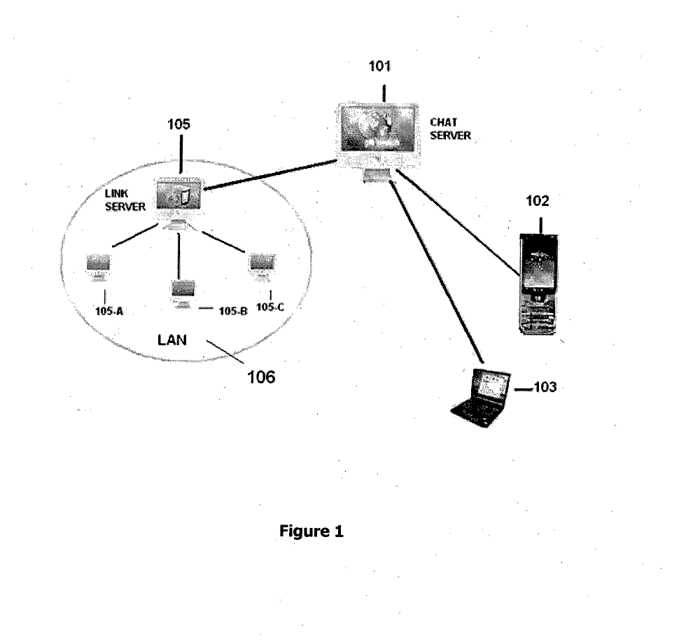

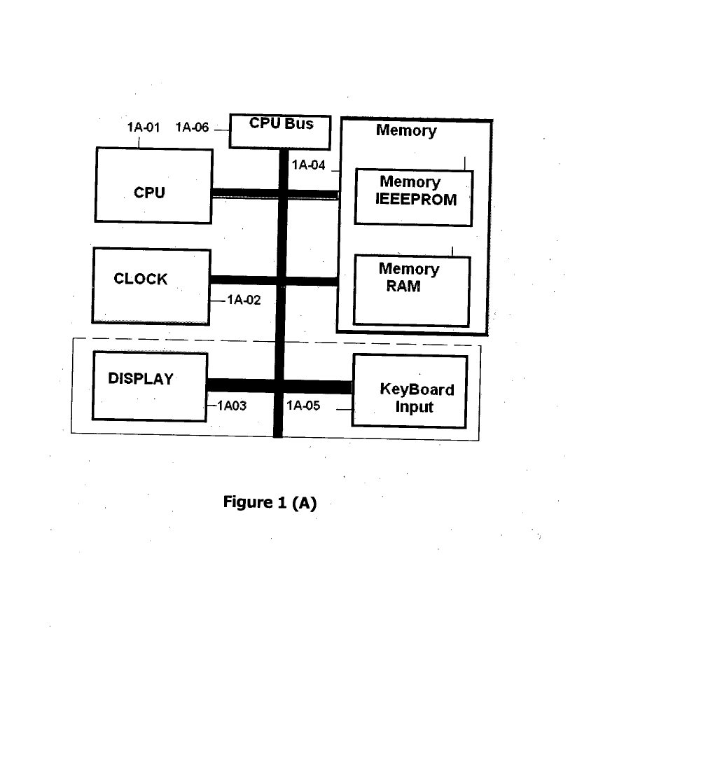

FIG. 1 illustrates a diagrammatic representation of an environment in which system (100) may operate, in accordance with one or more embodiments of the present disclosure. Environment includes a network (LAN) 106 and a plurality of telecommunication devices 102,103,105 (A, B, C). Examples of telecommunication devices include a mobile phone, a smart phone, a cordless phone or a landline phone. Plurality of telecommunication devices 102,103,105 (A, B, C) uses various services that are provided through network 101. Examples of network 101 include a CDMA network, a GSM network, the Internet, a UMTS network, a TDMA network, and the like. It should be noted that network 106 can be a wired network or a wireless network.

Also, (chat) first server (101) is communicative coupled with said plurality of telecommunication devices/client devices 102,103,105 (A, B, C). A first (Chat) Server 102,103,105 (A, B, C) is a specialized server computer to enable users to use client computers to instantly communicate via text, images, videos etc.

The telecommunication devices/client devices 102,103,105 (A, B, C) are operable by a plurality of user(s).

The (Chat) first server 102,103,105 (A, B, C) of the instant invention comprises of components as shown in FIG. 1(A).

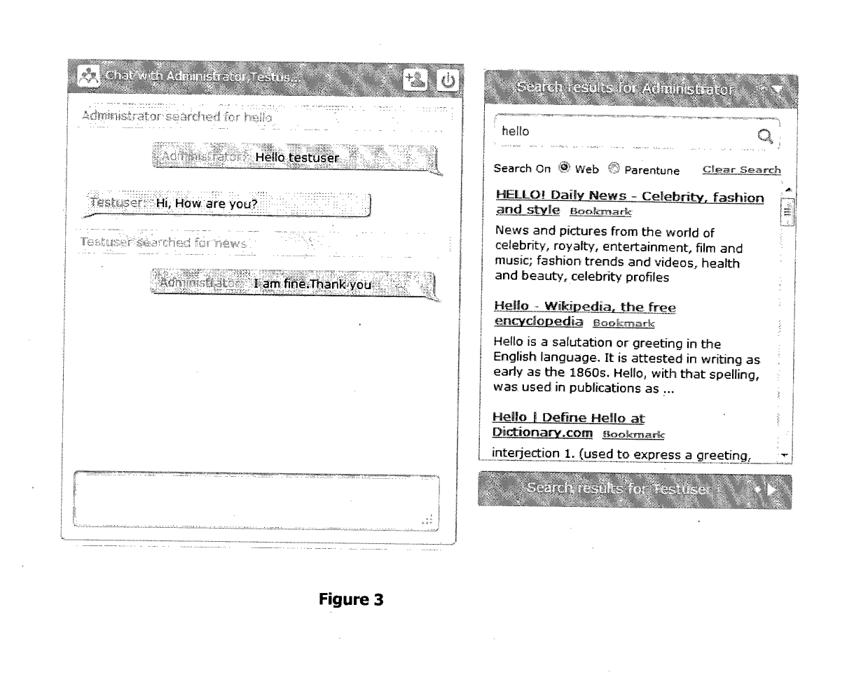

A (registered) user (105-A) initiates and requests for a communication channel with a (chat) first server (101) for communicating with another (registered) user (105-B) (105-C). The (chat) first server (101) in response to said request provides a (chat) user interface (as illustrated in FIG. 3 below) for said users (105-A)(105-B) (105-C). The users (105-A) (105-B) (105-C). are thus enabled to exchange messages over said communication channel via the (chat) first server (101) and (link) second server (105).

A (link) second server (105) in known hypermedia systems refers to a server typically configured to manage hypermedia information, such as links and anchors associated with each resource on the network.

In a typical link server enabled system, (link) second server (105) and a set of client device coexist. The client devices in such technical scheme manage the display, and user interaction etc.

In one of the advantageous embodiment of the invention, a particular user e.g. user operating at a client device (105-A) may communicate a request for searching a particular keyword(s) to another user e.g. a user operating at (105-C). Said communicating user in response, may choose to perform a search at his/her client device (105-C). Further, the (chat) first server (101) is specifically configured to, simultaneously and in parallel, present said search process in progress and results so produced in real time at the client device (105-A) of said requesting user.

Thus, the requesting user, in essence, perceives said search process is being carried out at his/her client device (105-A), even though the search is being performed at the client device (105-C) of another user.

Hence, the results so obtained are immediately available to the client device (105-A) operated by requesting user. Such an advantageous embodiment, utilizing the configured (chat) first server (101), allows the communicating users to collaborate in real time and increasing the overall efficiency of the system (100).

A typical search as carried out by the client devices of the instant invention makes use of following features and/or components e.g. providing a search box at the (chat) graphical window and the user can search for information within the (chat) graphical window. User may optionally search locally in a Local Area Network as well as World Wide Web.

The web-search in the present invention is implemented in plugin fashion and hence can be integrated with any search API (Application Program Interface) to fetch results from internet.

Within the realms of the present invention, a user can bookmark a search result, there by storing the links in the (chat) communication history. Also, user can bookmark search results from other (chat) communication member's search window.

This feature enables user to associate relevant search results with the context of the communication (chat).

Also, as elaborated above user can view search results of other communication (chat) members i.e. observe what other members are searching for.

A typical architecture of an exemplary network environment in which the communication (chat) server of the present invention operates is explained with reference to FIG. 1-A.

The relevant components of communication (chat) server (101) and link server (105) of the present invention selectively comprise of the following:

The CPU bus (1A-6) is, essentially, an interconnection wires that all subsystems are connected to. In general, only one pair of devices can talk to each other at a time, so communication of the bus must be coordinated to prevent message collisions. This coordination is often handled by the CPU (1A-01).

The central processing unit (CPU) (1A-01) executes instructions contained in memory (1A-04). These instructions are executed at a rate specified by the computer's clock (1A-02). The CPU (1A-01) needs to access two different types of memory (1A-04) in order to execute a program. There are two types of memories used in micro-controllers. These are read-only memory (ROM) ( ) and random access memory (RAM).

In a typical micro-controller, read-only memory (ROM) ( ) is used to store permanent programs, operating drivers, and data. Many micro-controllers use erasable programmable read-only memory (EPROM) or electrically, erasable programmable read-only memory (EEPROM) to store programs, operating drivers, and data. EPROM and EEPROM are non-volatile memories. Random access memory or RAM ( ) is used to temporarily store data and instructions.

The central processing unit (CPU) of the instant invention is specifically configured to_ present a search process in progress and the corresponding results so produced in real time, simultaneously and in parallel, at a plurality of client devices, including the client device (105-A) of a requesting user that requested for search results. It will be apparent to a person ordinarily skilled in the art that the system can be implemented in the form of hardware, software, firmware, or a combination thereof.

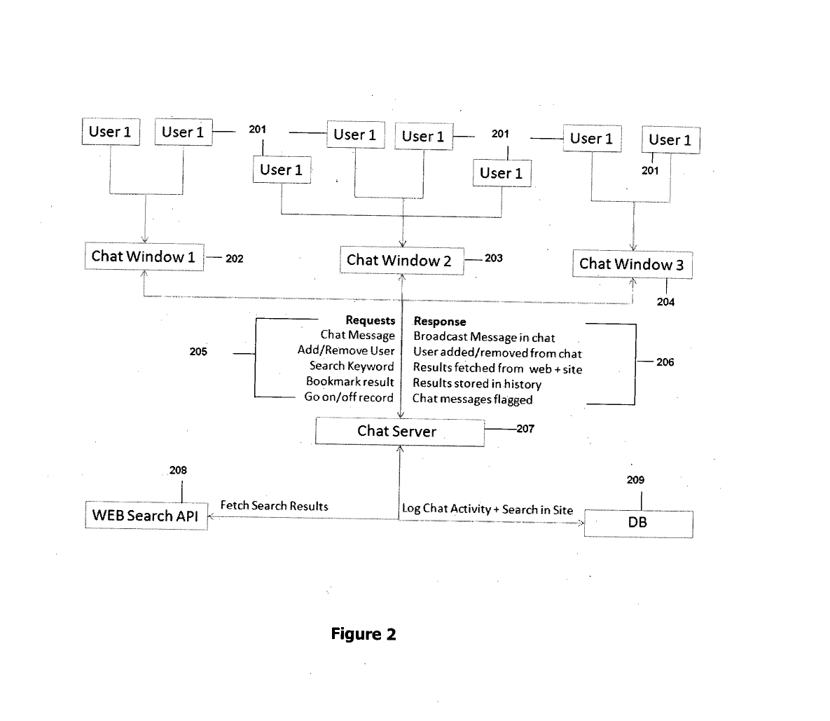

FIG. 2 illustrates a diagram depicting block architecture of the instant invention in accordance with an embodiment of the present disclosure.

A typical user (201) can open multiple (chat) graphical windows (202) (203) (204) at client machines for communicating with (chat) first server. The client machine is configurable to forward a plurality of requests (205) towards (chat) first server, including but not limited to, sending a (chat) message, adding and/or removing participating users, searching keyword(s), book marking a search result, going offline and/or online etc.

Similarly, (chat) first server is at least configured to respond (206) by broadcasting message in a communication (chat), add or remove users from the communication (chat), fetching results from web resources, storing results in history, flagging (chat) communication messages etc.

(Chat) first server is also configured to log all (chat) communication operations as log records in a database (209) and also to fetch search results.

FIG. 3 illustrates an exemplary screen shot of the (chat) graphical window (301) as generated by the (chat) first server (207) of the present invention, in accordance with the present disclosure.

It will be apparent to those having ordinary skill in this art that various modifications and variations may be made to the embodiments disclosed herein, consistent with the present disclosure, without departing from the spirit and scope of the present disclosure. Other embodiments consistent with the present disclosure will become apparent from consideration of the specification and the practice of the description disclosed herein.

We claim:

1. A method for providing multithreaded communication in a network environment, comprising:
initiating a request by at least a first client device towards a first server for allocation of a communication channel(s) for communicating with a second client device and carrying out a plurality of predetermined tasks;
providing a user interface(s) by the first server coupled with a second server, to said first client device and said second client device as an indication of allocation of the communication channel;
delegating a predetermined task having measurable results by the first client device, to be carried out by the second client device;
performing said task(s) by the second client device;
wherein the first server in combination with the second server is specifically configured to simultaneously and in parallel forward and render task progress and generated results on execution of said task in real time at the first client device and second client device.

2. A method for providing multithreaded communication as claimed in claim 1, wherein first client device and second client device comprise of a plurality of telecommunication devices that are configured to perform two-way communication.

3. A method for providing multithreaded communication as claimed in claim 1, wherein the first server is a specialized server computer to enable users to use client devices to instantly communicate via text, images, videos etc.

4. A method for providing multithreaded communication as claimed in claim 1, wherein the second server is link server configured to manage hypermedia information, comprising of links and anchors associated with predefined resource(s) on the network.

5. A method for providing multithreaded communication as claimed in claim 1, wherein the user interface comprises of graphical user interface having at least one graphical window for accepting user input.

6. A method for providing multithreaded communication as claimed in claim 1, wherein predetermined task is a request for search based on predetermined criteria and measurable results are search results.

7. A method for providing multithreaded communication as claimed in claim 2, wherein telecommunication devices are electronic devices comprise of a mobile device, a, a cordless device, landline phone, tablet computer etc.

8. A system for providing multithreaded communication in a network environment, comprising:
a first client device configured to initiate a request for allocation of a communication channel(s), carry out a plurality of predetermined tasks, and delegate said predetermined task(s) having measurable results;
a first server coupled to a second server, configured to receive said request for allocation of communication channel(s), provide a user interface(s) to said first client device and a second client device as an indication of allocation of the communication channel;
the second client device configured to perform at least said task(s) delegated by the first device;
wherein the first server in combination with the second server is specifically configured to simultaneously and in parallel forward and render task progress and generated results on execution of said task in real time at the first client device and second client device.

9. A system for providing multithreaded communication as claimed in claim 8, wherein the first server is a specialized server computer to enable users to use client devices to instantly communicate via text, images, videos etc.

10. A system for providing multithreaded communication as claimed in claim 8, wherein the second server is link server configured to manage hypermedia information, comprising of links and anchors associated with predefined resource(s) on the network.

11. A system for providing multithreaded communication as claimed in claim 8, wherein the user interface comprises of graphical user interface having at least one graphical window for accepting user input.

12. A system for providing multithreaded communication as claimed in claim 8, wherein predetermined task is a request for search based on predetermined criteria and measurable results are search results.

13. A system for providing multithreaded communication as claimed in claim 9, wherein telecommunication devices are electronic devices comprise of a mobile device, a, a cordless device, landline phone, tablet computer etc.
